(19) United States
(12) Patent Application Publication
(10) Pub. No.: US 2008/0032769 A1
(43) Pub. Date: Feb. 7, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/640,387

(22) Filed: Dec. 18, 2006

Related U.S. Application Data
(60) Provisional application No. 60/835,437, filed on Aug. 4, 2006.

(51) Int. Cl. A63F 13/00; A63F 9/24

(52) U.S. Cl. 463/20

(57) ABSTRACT

An arrangement area for arranging plural symbols and a selection area for displaying selection object symbols are provided to different parts of a display. The plural selection object symbols are displayed in the selection area. Among the selection object symbols, a scatter symbol is set by a player. The plural symbols including the scatter symbol are rearranged in the display. It is awarded a payout determined by a combination of symbols rearranged on a payline. In addition, it is awarded a payout determined on the basis of the scatter symbols rearranged on and out of the payline.

### CROSS REFERENCE TO RELATED APPLICATION

This application claims the benefit of U.S. Provisional Application No. 60/835,437, filed on Aug. 4, 2006.

### BACKGROUND OF THE INVENTION

1. Field of the Invention

The invention relates to a slot machine and a playing method thereof.

2. Description of Related Art

In a conventional slot machine, when a player inserts a game medium such as coin or bill into an insertion slot of the slot machine and inputs a spin button, plural symbols are scroll-displayed in a display mounted on a front of a cabinet and the symbols are then stopped automatically.

In such slot machine, as disclosed in U.S. Pat. No. 6,604,999 B2 or U.S. Patent No. 2002065124A1, for example, when the symbols stopped on a payline constitute a predetermined combination, predetermined number of game media are paid out. In addition, when a certain symbol referred to as scatter symbol is displayed on the display, predetermined number of game media are paid out in accordance with the number of scatter symbols displayed, irrespective of the payline. In other words, in the conventional slot machine, the payout is made in combination with the two methods.

The invention provides a slot machine having an entertainment characteristic, which is not provided to the prior art, and a playing method thereof.

### SUMMARY OF THE INVENTION

The invention provides a slot machine comprising structures below and having a display and a game controller. The display has a payline and arranges plural symbols including a scatter symbol. The game controller has plural types of selection object symbols. In addition, the game controller sets at least one of the selection object symbols having a type corresponding to a selection signal inputted from an exterior, as the scatter symbol. Further, the game controller rearranges the symbols to award a payout determined by a combination of the symbols rearranged on the payline and to award a payout determined on the basis of the scatter symbols rearranged on and out of the payline.

In the slot machine of the invention, when a selection signal is inputted from the exterior, it is set a scatter symbol corresponding to the selection signal, among the plural types of the selection object symbols. Then, the symbols including the scatter symbol are rearranged. After that, the payout is awarded on the basis of a combination of the symbols rearranged on the payline and the scatter symbols rearranged on and out of the payline.

The invention provides a slot machine comprising structures below and having a display and a game controller. The display arranges a scatter symbol. The game controller has plural types of selection object symbols. In addition, the game controller sets at least one of the selection object symbols having a type corresponding to a selection signal inputted from an exterior, as the scatter symbol. Further, the game controller rearranges the scatter symbol and awards a payout determined on the basis of the scatter symbol rearranged.

In the slot machine of the invention, when a selection signal is inputted from the exterior, it is set a scatter symbol corresponding to the selection signal, among the plural types of the selection object symbols. Then, the symbols including the scatter symbol are rearranged. After that, the payout is awarded on the basis of the scatter symbol rearranged.

The invention provides a slot machine comprising structures below and having a display and a game controller. The display has a payline and arranges plural symbols including a scatter symbol. The game controller provides an arrangement area for arranging the plural symbols and a selection area for displaying selection object symbols to different parts. The game controller has plural types of selection object symbols to be displayed in the selection area. The game controller sets at least one of the selection object symbols having a type corresponding to a selection signal inputted from an exterior, as the scatter symbol. The game controller rearranges the symbols to award a payout determined by a combination of the symbols rearranged on the payline and to award a payout determined on the basis of the scatter symbols rearranged on and out of the payline. When it is made a predetermined unit game-number after selecting the scatter symbol, the game controller receives selection of the scatter symbol after a next game.

In the slot machine of the invention, the arrangement area and the selection area are provided to different parts of the display. The selection object symbols are arranged in the selection area. When a selection signal is inputted from the exterior, it is set a scatter symbol corresponding to the selection signal, among the plural types of the selection object symbols. Then, the symbols including the scatter symbol are rearranged in the arrangement area. After that, the payout is awarded on the basis of a combination of the symbols rearranged on the payline and the scatter symbols rearranged on and out of the payline. In addition, when it is made a predetermined unit game-number, it is received selection of the scatter symbol after a next game.

The invention provides a slot machine comprising structures below and having a display and a game controller. The display has a payline and arranges plural symbols including a scatter symbol. The game controller provides an arrangement area for arranging the plural symbols and a selection area for displaying selection object symbols to different parts of the display. The game controller changes a selection-number of the selection object symbols to be displayed in the selection area, and sets, among the selection object symbols, at least one of the selection object symbols having a type corresponding to a selection signal inputted from an exterior, as the scatter symbol. The game controller rearranges the symbols to award a payout determined by a combination of the symbols rearranged on the payline and to award a payout determined on the basis of the scatter symbols rearranged on and out of the payline.

In the slot machine of the invention, the arrangement area and the selection area are provided to different parts of the display. The selection object symbol whose selection-number is changed is arranged in the selection area. When a selection signal is inputted from the exterior, it is set a scatter symbol corresponding to the selection signal, among the plural types of the selection object symbols. Then, the symbols including the scatter symbol are rearranged in the arrangement area. After that, the payout is awarded on the basis of a combination of the symbols rearranged on the payline and the scatter symbols rearranged on and out of the payline.

The invention provides a slot machine comprising structures below and having a display and a game controller. The display has a payline and arranges plural symbols including a scatter symbol. The game controller provides an arrangement area for arranging the plural symbols and a selection area for displaying selection object symbols to different parts of the display. The game controller changes a selection-number of the selection object symbols to be displayed in the selection area, and sets, among the selection object symbols, at least one of the selection object symbols having a type corresponding to a selection signal inputted from an exterior, as the scatter symbol. The game controller rearranges the symbols to award a payout determined by a combination of the symbols rearranged on the payline and to award a payout determined on the basis of the scatter symbols rearranged on and out of the payline. When it is made a predetermined unit game-number after selecting the scatter symbol, the game controller receives selection of the scatter symbol after a next game.

In the slot machine of the invention, the arrangement area and the selection area are provided to different parts of the display. The selection object symbol whose selection-number is changed is arranged in the selection area. When a selection signal is inputted from the exterior, it is set a scatter symbol corresponding to the selection signal, among the plural types of the selection object symbols. Then, the symbols including the scatter symbol are rearranged in the arrangement area. After that, the payout is awarded on the basis of a combination of the symbols rearranged on the payline and the scatter symbols rearranged on and out of the payline. When it is made a predetermined unit game-number, it is received selection of the scatter symbol after a next game.

The invention provides a playing method of a slot machine having structures below. A selection signal is received from an exterior. Among plural types of selection object symbols, it is set at least one of the selection object symbols having a type corresponding to the selection signal, as a scatter symbol. Plural symbols including the scatter symbol are rearranged in a display. It is awarded a payout determined by a combination of the symbols rearranged on a payline and a payout determined on the basis of the scatter symbols rearranged on and out of the payline.

In the playing method of the slot machine of the invention, when a selection signal is inputted from the exterior, it is set a scatter symbol corresponding to the selection signal, among the plural types of the selection object symbols. Then, the symbols including the scatter symbol are rearranged. After that, the payout is awarded on the basis of a combination of the symbols rearranged on the payline and the scatter symbols rearranged on and out of the payline.

The invention provides a playing method of a slot machine having structures below. A selection signal is received from an exterior. Among plural types of selection object symbols, it is set at least one of the selection object symbols having a type corresponding to the selection signal, as a scatter symbol. The scatter symbol is rearranged in a display and it is awarded a payout determined on the basis of the scatter symbol rearranged.

In the playing method of the slot machine of the invention, when a selection signal is inputted from the exterior, it is set a scatter symbol corresponding to the selection signal, among the plural types of the selection object symbols. Then, the symbols including the scatter symbol are rearranged. After that, the payout is awarded on the basis of the scatter symbol rearranged.

The invention provides a playing method of a slot machine having structures below. An arrangement area for arranging the plural symbols and a selection area for displaying selection object symbols are provided to different parts of a display. A selection signal is received from an exterior. Among the plural types of the selection object symbols, it is set at least one of the selection object symbols having a type corresponding to the selection signal, as a scatter symbol. The plural symbols including the scatter symbol are rearranged in the display. It is awarded a payout determined by a combination of the symbols rearranged on a payline and a payout determined on the basis of the scatter symbols rearranged on and out of the payline. When it is made a predetermined unit game-number after selecting the scatter symbol, it is received selection of the scatter symbol after a next game.

In the playing method of the slot machine of the invention, the arrangement and selection areas are provided to different part of the display. The selection object symbols are arranged in the selection area. When a selection signal is inputted from the exterior, it is set a scatter symbol corresponding to the selection signal, among the plural types of the selection object symbols. Then, the symbols including the scatter symbol are rearranged in the arrangement area. After that, it is awarded a payout determined on the basis of by a combination of the symbols rearranged on a payline and the scatter symbols rearranged on and out of the payline. In addition, when it is made a predetermined unit game-number, it is received selection of the scatter symbol after a next game.

The invention provides a playing method of a slot machine having structures below. An arrangement area for arranging the plural symbols and a selection area for displaying selection object symbols are provided to different parts of a display. A selection signal is received from an exterior. A selection-number of the selection object symbols to be displayed in the selection area is changed, and among the selection object symbols, it is set at least one of the selection object symbols having a type corresponding to the selection signal, as a scatter symbol. The plural symbols including the scatter symbol are rearranged in the display. It is awarded a payout determined by a combination of the symbols rearranged on a payline and a payout determined on the basis of the scatter symbols rearranged on and out of the payline.

In the playing method of the slot machine of the invention, the arrangement and selection areas are provided to different part of the display. The selection object symbol whose selection-number is changed is arranged in the selection area. When a selection signal is inputted from the exterior, it is set a scatter symbol corresponding to the selection signal, among the plural types of the selection object symbols. Then, the symbols including the scatter symbol are rearranged in the arrangement area. After that, the payout is awarded on the basis of a combination of the symbols rearranged on the payline and the scatter symbols rearranged on and out of the payline.

The invention provides a playing method of a slot machine having structures below. An arrangement area for arranging the plural symbols and a selection area for displaying selection object symbols are provided to different parts of a display. A selection signal is received from an exterior. A selection-number of the selection object symbols to be displayed in the selection area is changed, and among the selection object symbols, it is set at least one of the selection object having a type corresponding to the selection signal, as a scatter symbol. The plural symbols including the scatter symbol are rearranged in the display. It is awarded a payout determined by a combination of the symbols rearranged on a payline and a payout determined on the basis of the scatter symbols rearranged on and out of the payline. When it is made a predetermined unit game-number after selecting the scatter symbol, it is received selection of the scatter symbol after a next game.

In the playing method of the slot machine of the invention, the arrangement and selection areas are provided to different part of the display. The selection object symbol whose selection-number is changed is arranged in the selection area. When a selection signal is inputted from the exterior, it is set a scatter symbol corresponding to the selection signal, among the plural types of the selection object symbols. Then, the symbols including the scatter symbol are rearranged in the arrangement area. After that, the payout is awarded on the basis of a combination of the symbols rearranged on the payline and the scatter symbols rearranged on and out of the payline. In addition, when it is made a predetermined unit game-number, it is received selection of the scatter symbol after a next game.

### BRIEF DESCRIPTION OF THE DRAWINGS

FIG. 1 illustrates a playing method of a slot machine;

FIG. 2 is a block diagram of a slot machine;

FIG. 3 illustrates a display screen;

FIG. 4 illustrates a display screen;

FIG. 5 illustrates a display screen;

FIG. 6 illustrates a display screen;

FIG. 7 illustrates a display screen;

FIG. 8 shows symbols and code numbers thereof;

FIG. 9 is a perspective view showing an external appearance of a slot machine;

FIG. 10 is a block diagram showing a control circuit of a slot machine;

FIG. 11 is a flow chart of a game executing process;

FIG. 12 is a flow chart of a scatter symbol selecting process;

FIG. 13 illustrates a playing method of a slot machine;

FIG. 14 is a block diagram of a slot machine;

FIG. 15 is a flow chart of a scatter symbol selecting process, and

FIG. 16 illustrates a playing method of a slot machine.

### DESCRIPTION OF THE PREFERRED EMBODIMENTS

### Embodiment 1

It will be described an embodiment 1 of a slot machine and a playing method thereof according to the invention.

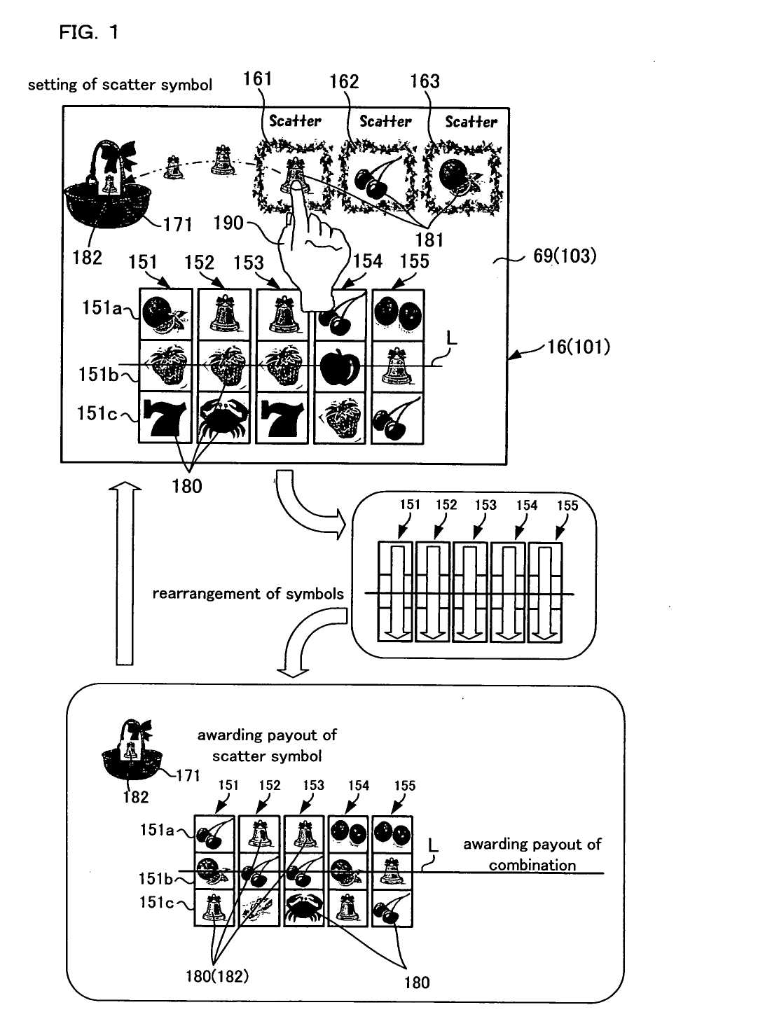

As shown in FIG. 1, a slot machine executes a playing method comprising steps of receiving a selection signal from an exterior, setting, among plural types of selection object symbols 181, at least one of the selection object symbols 181 having a type corresponding to the selection signal as a scatter symbol 182, rearranging plural symbols 180 including the scatter symbol 182 in a display unit 101, awarding a payout determined by a combination of the symbols 180 rearranged on a payline L and awarding a payout determined on the basis of the scatter symbols 182 rearranged on and out of the payline L.

Further, the slot machine 10 executes a playing method comprising a step of providing an arrangement area for arranging plural symbols and a selection area for displaying selection object symbols to different parts of the display unit 101.

Herein, the “arrangement” means a state in which the symbols 180 including the scatter symbol 182 are allowed to be visible with naked eyes of an exterior player. In other words, in FIG. 1, the symbols 180 are under state of being displayed in the display windows 151˜155. In the mean time, the “rearrangement” is meant by arranging the symbols 180 again after dismissing the arrangement of the symbols 180. In addition, the “payline” L is provided to determine a combination of the symbols 180. In other words, when the symbols 180 are rearranged on and out of the payline L, a combination is determined for only the symbols 180 rearranged on the pay line. As a result of the determination for a combination, when it is made a winning combination, it is carried out, for example, a process of paying out a coin in accordance with the winning combination.

In addition, the “scatter symbol” 182 is a symbol making it a condition that a winning is made through only the arrangement thereof, irrespective of the payline L. In other words, when the scatter symbol 182 is rearranged, a winning is made and it is carried out, for example, a process of paying out a coin on the basis of the number of all the scatter symbols 182 rearranged on and out of the payline L. Furthermore, the “symbol” is meant by all symbols used in the slot machine 10 and includes the scatter symbol 182 and the selection object symbols 181. The payline L, the symbol 180, the scatter symbol 182 and the winning combination will be more specifically described later.

(Display Unit 101)

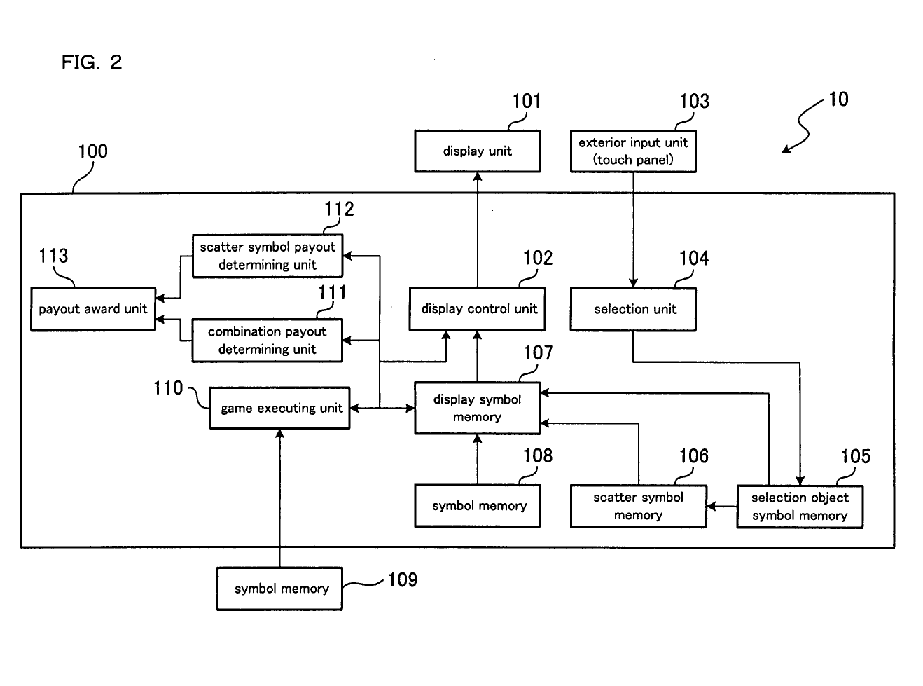

As shown in FIG. 2, the slot machine executing the above playing method is provided with a display unit 101 (display) and a game controller 100. The display unit 101 is structured to have the payline L and to arrange the plural symbols including the scatter symbol.

The display unit 101 may be a mechanical structure with a reel device for arranging the symbols by rotation of a reel or electrical structure with a video reel on which an image is displayed for arranging the symbols. Further, the display unit 101 may be a structure of combining a mechanical structure (reel) and an electrical structure (video reel). The electrical structure may include a liquid crystal device, a CRT (cathode-ray tube), a plasma display and the like. A detailed structure of the display unit 101 will be described later.

(Game Controller 100)

The game controller 100 has plural types of selection object symbols and is also structured to execute a first process of setting at least one of the selection object symbols having a type corresponding to a selection signal inputted from an exterior, as a scatter symbol, a second process of rearranging the symbols to award a payout determined by a combination of symbols rearranged on the payline and a third process of awarding a payout determined on the basis of the scatter symbols rearranged on and out of the payline. In other words, the game controller 100 has the plural types of selection object symbols and also comprises a first processing unit, a second processing unit and a third processing unit. Herein, the “selection object symbol” is a symbol which will be set as a scatter symbol by player's selection.

Further, the game controller 100 is also structured to execute a fourth process of providing an arrangement area for arranging the plural symbols and a selection area for displaying the selection object symbols to different parts of the display unit 101. In other words, the game controller 100 comprises a fourth processing unit in addition to the first to third processing units.

The game controller 100 comprises a selection object symbol memory 105 for storing the plural types of selection object symbols, a scatter symbol memory 106 for storing a selection object symbol selected by a player as a scatter symbol, a symbol memory 108 for storing all symbols including the scatter symbol and a display symbol memory 107 for storing the symbols in the respective memories 105, 106, 108 as a display symbol. The display symbol memory 107 can be accessed by a display control unit 102. The display control unit 102 sets the arrangement area for arranging the plural symbols and the selection area for displaying the selection object symbols in the different parts of the display unit 101. In addition, the display control unit 102 reads out the symbol in the display symbol memory 107 under control of a game executing unit 110 and displays the plural symbols in the arrangement areas and the selection object symbols in the selection area. A detailed display state will be described later.

In addition, the game controller 100 comprises a selection unit 104 for specifying the selection object symbol having a type corresponding to the selection signal and setting the specified selection object symbol as a scatter symbol. The selection unit 104 receives the selection signal from an exterior input unit 103. The exterior input unit 103 is separately provided from the game controller 100 and receives an input of the selection signal from an exterior by a player. Meanwhile, the exterior input unit 104 may be a touch panel provided to the display unit 101, or a mouse or selection button.

Further, the game controller 100 is connected to a game start unit 109. The game start unit 109 has a function of outputting a game start signal in accordance with control of the player. The game controller 100 comprises a game executing unit 110 for rearranging the symbols with an input of a game start signal, as trigger, from the game start unit 109, a combination payout determining unit 111 for determining a payout determined by a combination of the symbols rearranged on the payline in a unit game, a scatter symbol payout determining unit 112 for determining a payout determined on the basis of the scatter symbols rearranged on and out of the payline and a payout award unit 113 for awarding the respective payouts determined in the combination payout determining unit 111 and the scatter symbol payout determining unit 112.

In the mean time, each block of the game controller 100 may be structured with a hardware or software, as required.

(Operation of Game Controller 100)

In the above structure, an operation of the game controller 100 is described. First, the selection object symbols in the selection object symbol memory 105 are displayed in the display unit 101 by the display symbol memory 107 and the display control unit 102. Thereby, a player can select a desired scatter symbol among the selection object symbols displayed in the display unit 101.

Furthermore, in the display unit 101, the plural symbols are displayed in the arrangement area and the selection object symbols are displayed in the selection area. In other words, the game controller 100 executes the fourth process of providing the arrangement area for arranging the plural symbols and the selection area for displaying the selection object symbols to different parts of the display unit 101. Thereby, the player can easily recognize the selection object symbols because the selection object symbols are displayed in the selection area separately from the arrangement area.

Next, it is received an input of a selection signal by the player using the exterior input unit 103. The selection signal inputted from the exterior input unit 103 is contrasted with the types of the selection object symbols in the selecting unit 104, so that it is selected a selection object symbol having a type corresponding to the selection signal. The selection object symbol selected is stored in the scatter symbol memory 106. Thereby, the game controller 100 executes the first process of setting at least one of the selection object symbols having a type corresponding to the selection signal inputted from an exterior, as a scatter symbol.

The scatter symbol in the scatter symbol memory 106 is stored in the display symbol memory 107. In the mean time, the symbol in the symbol memory 108 is stored in the display symbol memory 107. The symbols including the scatter symbol in the display symbol memory 107 can be displayed in the display unit 101 by the display control unit 102. Then, when the game executing unit 110 executes a unit game, symbols relating to the unit game are displayed in the display unit 101, so that the symbols are rearranged.

Then, a payout, which is determined by a combination of the symbols rearranged on the payline, is awarded by the scatter symbol payout determining unit 112 and the payout award unit 113. In the mean time, a payout, which is determined on the basis of the scatter symbols rearranged on and out of the payline L, is awarded by the combination payout determining unit 111 and the payout award unit 113. Thereby, the game controller 100 executes the second process of rearranging the symbols to award a payout determined by a combination of symbols rearranged on the payline and the third process of awarding a payout determined on the basis of the scatter symbols rearranged on and out of the payline.

As can be clearly seen from the above operation, the slot machine 10 embodies the playing method of receiving a selection signal from an exterior, setting, among plural types of selection object symbols, at least one of the selection object symbols having a type corresponding to the selection signal as a scatter symbol, rearranging plural symbols including the scatter symbol in the display unit 101, awarding a payout determined by a combination of the symbols rearranged on the payline L and awarding a payout determined on the basis of the scatter symbols rearranged on and out of the payline L. Further, the slot machine 10 embodies the playing method of providing an arrangement area for arranging the plural symbols and a selection area for displaying selection object symbols to different parts of the display unit 101.

(Display State)

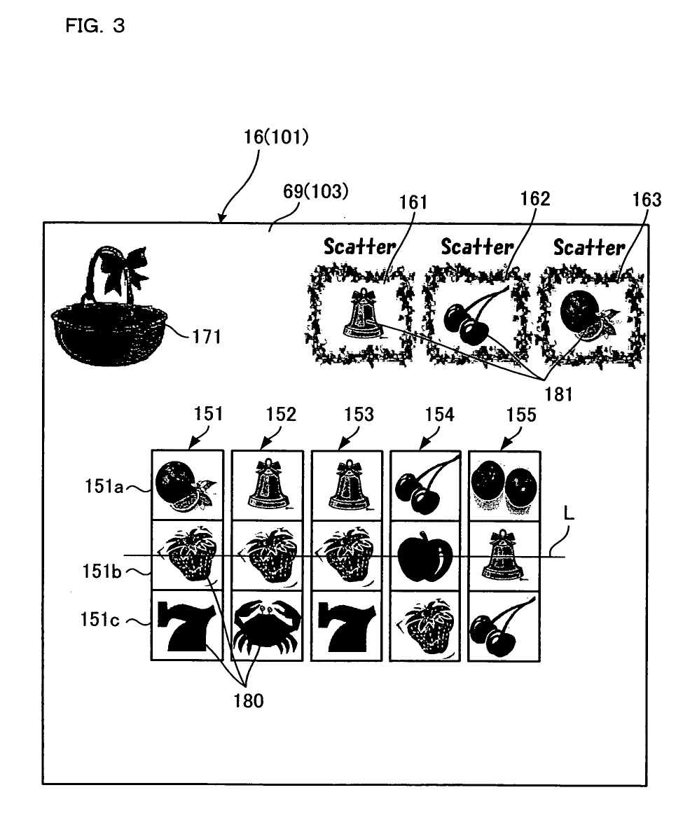

It is specifically described an example of a display state of the display unit 101, with respect to the operation processes of the slot machine 10 and the playing method. In the mean time, as shown in FIGS. 3 to 7, the display state is described with reference to a structure in which the display unit 101 arranges the symbols with a video reel manner and a touch panel 69 (exterior input unit 103) is provided to a display surface of the display unit 101.

The display unit 101 has display windows 151˜155 as the arrangement area for arranging the plural symbols. The display windows 151˜155 are arranged in a central part of the display unit 101. In the display windows 151˜155, symbol columns consisting of the plural symbols 180 are scroll-displayed. In addition, each of the display windows 151˜155 is divided into upper, center and lower stages 151a, 151b, 151c. Each of the symbols is stopped (arranged) in the respective stages 151a, 151b, 151c. For example, in FIG. 3, “ORANGE” is stopped in the upper stage 151a of the display window 151, “STRAWBERRY” is stopped in the center stage 151b of the display window 151 and “BLUE 7” is stopped in the lower stage 151c of the display window 151. As a result, the display windows 151˜155 display a symbol matrix consisting of 5 columns and 3 rows. In the mean time, the symbol matrix is not limited to 5 columns/3 rows.

In addition, the display unit 150 has three selection windows 161, 162, 163 as the selection area for displaying the selection object symbols 181. The selection windows 161, 162, 163 are arranged in a right-handed upper part of the display unit 151 so as not to overlap with the display windows 151˜155. “BELL,” “CHERRY” and “ORANGE”, which are the selection object symbols 181, are respectively displayed in the selection windows 161, 162, 163.

In the mean time, the selection object symbols 181 to be displayed in the selection windows 161, 162, 163 may be different symbols and three or less, and at least one of numbers and types thereof may be selected, among the plural types of the selection object symbols 181, by lottery. In addition, the number of the selection windows 161, 162, 163 is not limited to three and may be plural. Further, the selection windows 161, 162, 163 may be provided to an arbitrary position on condition that they can avoid the overlapping with the display windows 151˜155.

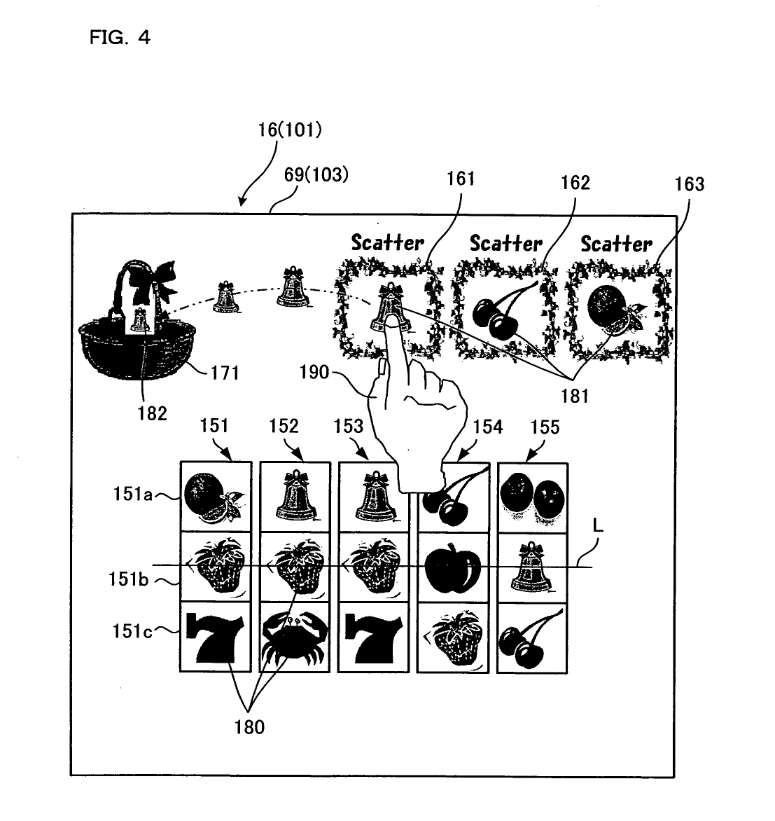

In addition, the display unit 101 has a scatter symbol display unit 171. The scatter symbol display unit 171 is basket-shaped, and displays the scatter symbol 182 as a received thing, as shown in FIG. 4. The scatter symbol display unit 171 is provided to a left-handed upper corner part of the display unit 101. In the mean time, the scatter symbol display unit 171 may be provided to an arbitrary position on condition that it can avoid the overlapping with the display windows 151˜155 and the selection windows 161, 162, 163.

In the display unit 101 structured as described above, the display state of FIG. 3 shows a state allowing the scatter symbol 182 to be selected among the selection object symbols 181. In other words, after the symbols 180 are rearranged in the display windows 151˜155, it is made a display state shown in FIG. 3 at the time when a next game is started. A received thing is not shown in the scatter symbol display unit 171. In addition, “BELL,” “CHERRY” and “ORANGE” are respectively displayed in the selection windows 161, 162, 163, as the selection object symbols 181. Meanwhile, the display unit 101 may display a character, change of background color or emphasis for urging the player to select the scatter symbol 182.

Thereby, the player can intuitively recognize that the player can select the scatter symbol 182 among the selection object symbols 181 by observing a state in which the received state is not displayed in the scatter symbol display unit 171 and a state in which the selection object symbols 181 are displayed in the selection windows 161, 162, 163, with naked eyes.

A display state of FIG. 4 shows a state of selecting the scatter symbol 182. Specifically, when the player pushes “BELL” of the selection object symbols 181 with a hand 190, the touch panel 69 produces a selection signal indicating position information of “BELL.” Then, “BELL,” which is specified on the basis of the selection signal, is moved to the scatter symbol display unit 171 while changing its size, and is received in the scatter symbol display unit 171. Thereby, the player can intuitively recognize that “BELL” has been set as the scatter symbol 182, by observing the successive movements of the selection object symbol 181 with naked eyes.

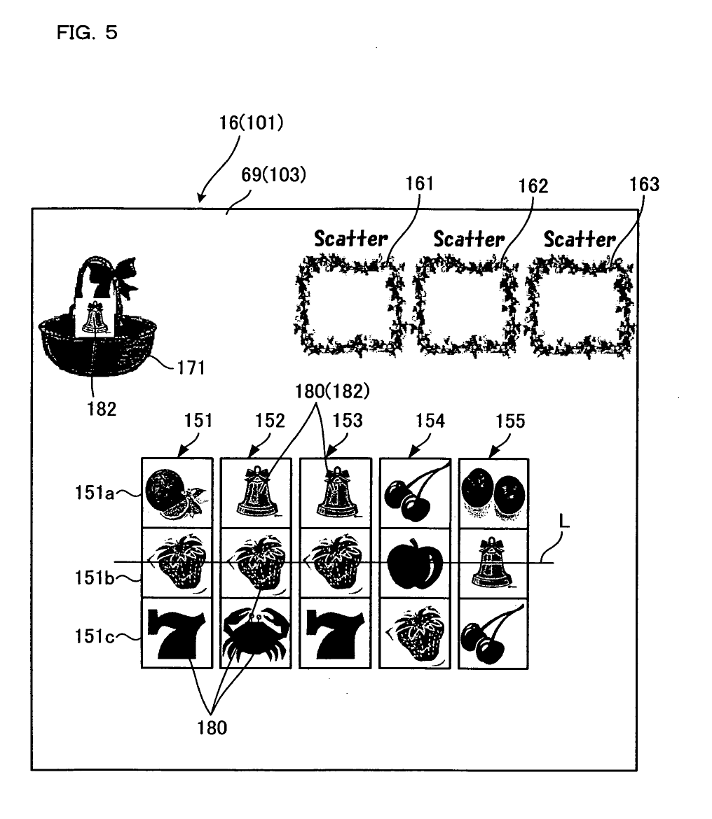

A display state of FIG. 5 shows a state after selecting the scatter symbol 182. Specifically, “BELL” is displayed in the scatter symbol display unit 171, as a received thing. In addition, the selection object symbols 181 disappear from the selection windows 161, 162, 163. As a result, the player can intuitively recognize that the process of receiving the selection of the scatter symbol 182 has been completed, by observing the state in which nothing is displayed in the selection windows 161,162, 163, with naked eyes.

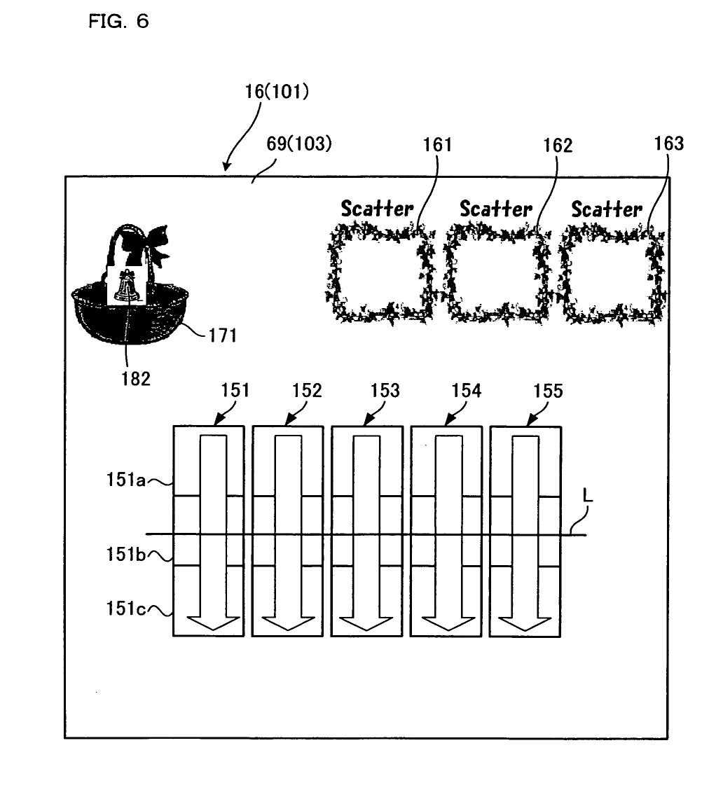

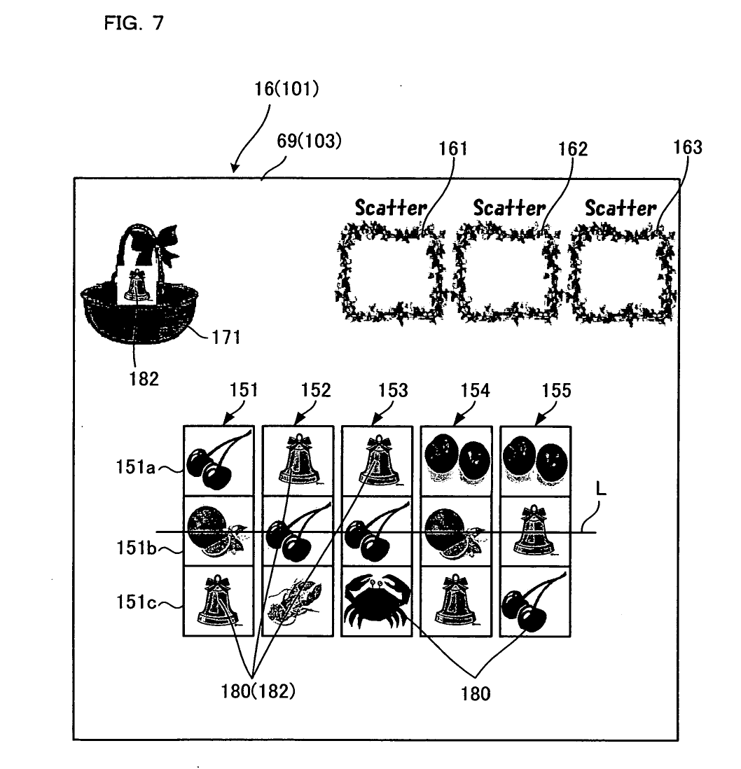

A display state of FIG. 6 shows a state in which a unit game is started. Specifically, the symbols 180 of the display windows 151˜155 are scroll-displayed. A display state of FIG. 7 shows a state in which the unit game has been completed. In other words, the symbols 180 of the display windows 151˜155 are rearranged.

(Symbol, Combination, etc.)

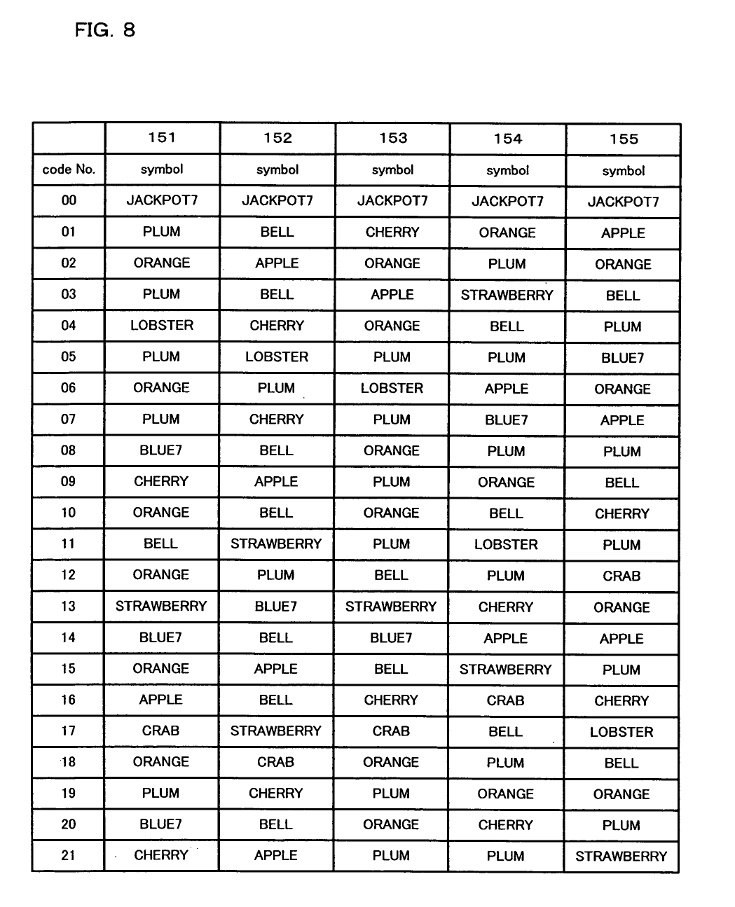

As shown in FIG. 8, the symbols 180 to be displayed in the display windows 151˜155 of the display unit 101 constitute columns of symbols. The symbols constituting the respective columns of symbols are given with one code number of 0˜21. Each of the columns of symbols is constituted with a combination of symbols of “JACKPOT 7,” “BLUE 7,” “BELL,” “CHERRY,” “STRAWBERRY,” “PLUM,” “ORANGE,” “APPLE,” “LOBSTER” and “CRAB.”

The three successive symbols in the columns of symbols are displayed (arranged) in the upper, center and lower stages 151a, 151b, 151c of the display windows 151˜155, respectively, so that they constitute a symbol matrix of 5 columns/3 rows. When a 1-BET button 26 or MAX-BET button 27 is pushed and then a spin button 23 is pushed, the symbols constituting the symbol matrix starts the scroll. When the scroll starts, the scrolls of the respective symbols are stopped (rearranged) after a predetermined time period has lapsed.

In addition, various winning combinations are predetermined with regard to the respective symbols. The winning combination is a combination that a combination of symbols stopped on the payline L becomes an advantageous state to the player. The advantageous state is a state in which a coin is paid out in accordance with the winning combination, the payout-number of coins is added to a credit, a bonus game is started, and the like.

Specifically, when a combination of “APPLE” symbol is stopped on the payline L, a bonus is triggered and a gaming state is shifted to a bonus game from a basic game. In addition, when a symbol of “CHERRY” is stopped on the payline L, 20coins (game medium) are paid out per one bet. When a symbol of “PLUM” is stopped on the payline L, 5 coins are paid out per one bet.

In the mean time, a bonus game is a gaming state that is more advantageous than a basic game. In one embodiment, the bonus game is a free game. The free game is a gaming state allowing a player to play a game for a predetermined number of times, without betting a coin. The bonus game is not particularly limited as long as it is a gaming state advantageous to the player, i.e., it is more advantageous than the basic game. For example, the bonus game may include a state in which it is possible to obtain more game medium than the basic game, a state in which it is possible to obtain a game medium in a higher probability than in the basic game, a state in which a game medium is less consumed than in the basic game, and the like. Specifically, a free game, a second game and the like are examples of the bonus game.

(Mechanical Structure)

In the followings, it will be described an example of the slot machine structured in a mechanical and electrical manner.

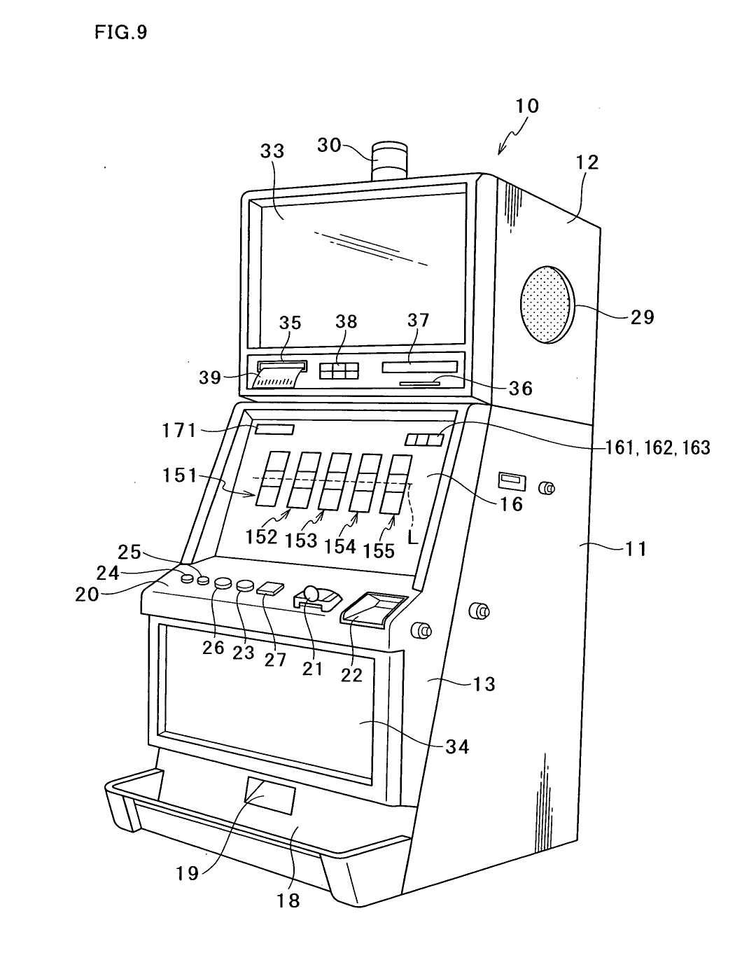

As shown in FIG. 9, the slot machine 10 is provided in a game arcade. The slot machine 10 executes a unit game by using a game medium. The game medium is a coin, bill or electronic negotiable information corresponding to them. Meanwhile, in the invention, the game medium is not particularly limited. For example, a medal, token, electronic money, ticket and the like can be used. The ticket is not particularly limited and may be a ticket with a barcode which will be described later.

The slot machine 10 comprises a cabinet 11, a top box 12 provided to an upper part of the cabinet 11 and a main door 13 provided to a front of the cabinet 11. The main door 13 is provided with a lower image display panel 16. The lower image display panel 16 has a transparent liquid crystal panel for displaying a variety of information. The lower image display panel 16 displays a video reel and a variety of information and effect images relating to a game. Specifically, the lower image display panel 16 displays the display windows 151˜155 of 5 columns/3 rows, the selection windows 161, 162, 163 and the scatter symbol display unit 171, as shown in FIG. 1, and other effect images, as required.

In the mean time, in this embodiment, it is exemplified a case where the symbols of 5 columns/3 rows are displayed with the lower image display panel 16. However, the invention is not limited thereto. For example, a mechanical reel having symbols provided to a periphery thereof may be rotated and stopped to display symbols which are beyond a display window 15.

One activated payline L is displayed in the lower image display panel 16. The payline L is set to horizontally traverse the center stages 151b of the display windows 151˜155. Meanwhile, in this embodiment, although the payline L traverses the center stages 151b of the display windows 151˜155, it may traverse the other stages of the display windows 151˜155. For example, the payline L may traverse the upper stages 151a or lower stages 151c of the display windows 151˜155. Alternatively, the payline L may traverse the lower stage 151c of the display window 151, the center stage 151b of the display window 152 and the upper stage 151a of the display window 153. Further, the payline L may be 2 or more. When two or more paylines L are provided, all paylines L may be activated and the number of paylines L relating to a predetermined condition such as bet-number of coins may be activated.

In the mean time, a credit-number display unit and a payout-number display unit may be displayed in the lower image display panel 16. The credit-number display unit displays a total number that the slot machine 10 can pay out to a player (which will be referred to as total credit-number). The payout-number display unit displays number of coins to be paid out when a combination of symbols stopped on the payline is a winning combination.

A touch panel 69 is provided to a front surface of the lower image display panel 16. The touch panel 69 has plural contact points in a matrix form of longitudinal and transverse directions and allows position information, which indicates longitudinal and transverse positions of the pressed contact points, to be outputted as a command signal. In the mean time, the touch panel 69 may be a touch panel adopted in a mobile terminal or ATM of a bank.

A control panel 20, a coin receiving slot 21 and a bill validator 22 are provided below the lower image display panel 16. The control panel 20 is provided with plural buttons 23˜27. The buttons 23˜27 allows instructions, which are related to a game progress by a player, to be inputted. The coin receiving slot 21 enables a coin to be received in the cabinet 11.

The control panel 20 is provided with a spin button 23, a change button 24, a cash out button 25, a 1-BET button 26 and a MAX-BET 27. The spin button 23 is a button for inputting an instruction to start the scroll of symbols. The change button 24 is a button to be used when a player asks a staff in the game arcade for exchange of money. The cash out button 25 is a button for inputting an instruction to pay out the coins of total credit-number into a coin tray 18.

The 1-BET button 26 is a button for inputting an instruction to bet one coin, among coins of the total credit-number, per one game. The MAX-BET button 27 is a button for inputting an instruction to bet maximum coins (for example, 50 coins), among coins of the total credit-number, per one game.

The bill validator 22 validates whether bill is normal or not and receives the normal bill into the cabinet 11. In the mean time, the bill validator 22 can read a ticket 39 having a barcode which will be described later. When the bill validator 22 reads the ticket 39 having a barcode, it outputs a reading signal relating to the read content to a main CPU 41.

A belly glass 34 is provided to a lower frontal surface of the main door 13, i.e., below the control panel 20. A character of the slot machine 10 and the like are drawn on the belly glass 34. An upper image display panel 33 is mounted to a front of the top box 12. The upper image display panel 33 has a liquid crystal panel and displays, for example, an effect image and an image indicating an introduction of a game content and an explanation of a game rule.

To the top box 12 is mounted a speaker 29 for outputting voice. A ticket printer 35, a card reader 36, a data displayer 37 and a keypad 38 are provided below the upper image display panel 33. The ticket printer 35 prints a barcode having data encoded thereto, such as credit-number, date and time, identification number of the slot machine 10 and the like, onto a ticket, thereby outputting the ticket 39 having the barcode. The player can play a game in another slot machine with the ticket 39 having a barcode and exchange the ticket 39 having a barcode with bill in a change booth of the game arcade.

The card reader 36 reads and writes the data from and into a smart card. The smart card is a card carried by a player, into which data for identifying the player and data relating to a game history of the player are memorized.

The data displayer 37 consists of a fluorescent display and the like, and displays the data read by the card reader 36 and the data inputted by the player through the keypad 38. The keypad 38 inputs instructions or data relating to a ticket issue.

(Electrical Structure)

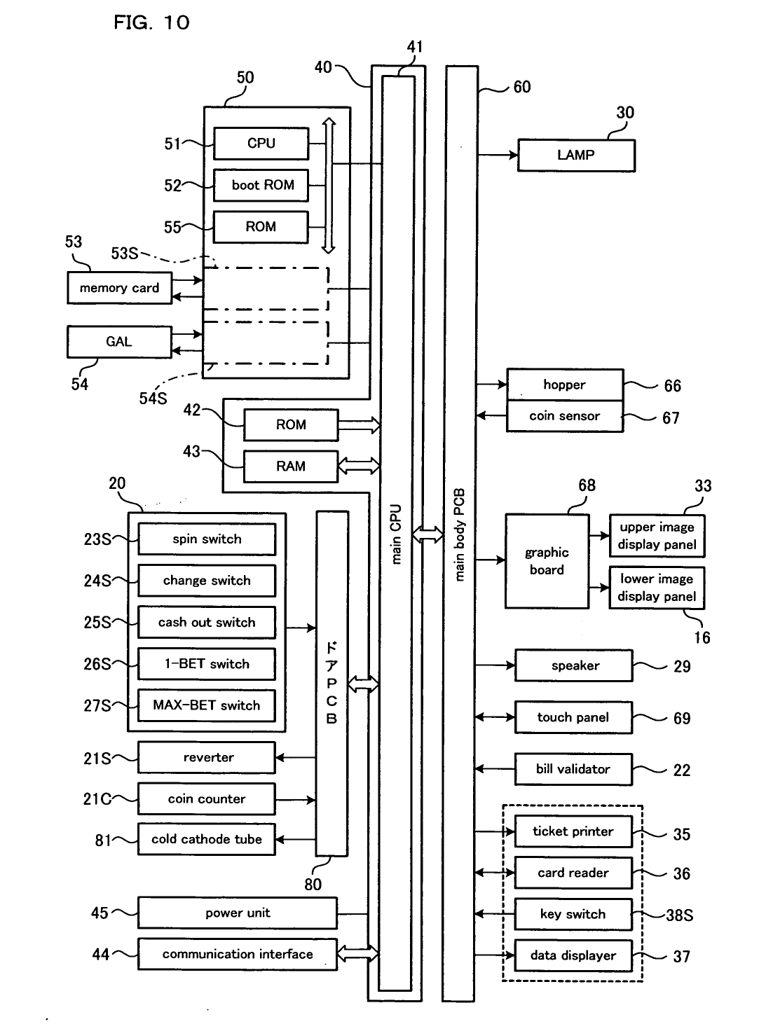

A control unit having the game controller 100 shown in FIG. 2 is mounted in the cabinet 11. As shown in FIG. 10, the control unit comprises a motherboard 40, a main body PCB (Printed Circuit Board) 60, a gaming board 50, a sub CPU, a door PCB 80, and various switches and sensors.

The gaming board 50 is provided with a CPU (Central Processing Unit) 51, a ROM 55 and a boot ROM 52 which are connected to each other by an internal bus, a card slot 53S corresponding to a memory card 53 and an IC socket 54S corresponding to a GAL (Generic Array Logic) 54.

The memory card 53 stores a game program and a game system program therein. The game program includes a stop symbol determining program. The stop symbol determining program is a program for determining a symbol (code number corresponding to the symbol) to be stopped on the payline L. The stop symbol determining program includes symbol weight data corresponding to each of plural payout rate (for example, 80%, 84%, 88%). The symbol weight data is data representing a correspondence relation between the code number of each symbol and 1 or plural random numbers belonging to a predetermined numerical range (0˜256) for each of the display windows 151˜155.

The payout rate is determined on the basis of data for setting a payout rate, which data is outputted from the GAL 54, and a stop symbol is determined on the basis of the symbol weight data corresponding to the payout rate.

Further, the memory card 53 stores various data used for the game program and the game system program. Specifically, the data representing a relationship between the symbols 180 displayed in the display windows 151˜155 and the code numbers is stored in a data table form shown in FIG. 8. Further, the selection object symbols 181 displayed in the selection windows 161, 162, 163 are stored. In the mean time, these data are transmitted to a RAM 43 of the motherboard 40 when executing the game program.

In addition, the card slot 53S is structured to insert and remove the memory card 53 and connected to the motherboard 40 through an IDE bus. Accordingly, it is possible to change a type or content of a game to be executed in the slot machine, by removing the memory card 53 from the card slot 53S, writing another game program and game system program in the memory card 53 and inserting the memory card 53 into the card slot 53S.

The game program includes a program relating to a game progress and a program for shifting a gaming state into a bonus game.

The GAL 54 is provided with plural input and output ports. When the data is inputted into the input ports, the GAL 54 outputs data corresponding to the inputted data from the output ports. The data outputted from the output ports is the data for setting a payout rate which has been described above.

The IC socket 54S is structured to attach and detach the GAL 54. The IC socket 54S is connected to the motherboard 40 through a PCI bus. Accordingly, it is possible to change the data for setting a payout rate which is outputted from the GAL 54, by detaching the GAL 54 from the IC socket 54S, rewriting the program stored in the GAL 54 and then attaching the GAL 54 to the IC socket 54S.

The CPU 51, the ROM 55 and the boot ROM 52, which are connected to each other by the internal bus, are connected to the motherboard 40 through the PCI bus. The PCI bus carries out a signal transfer between the motherboard 40 and the gaming board 50 and supplies power to the gaming board 50 from the motherboard 40. The ROM 55 stores nation identification information and an authentication program. The boot ROM 52 stores a preliminary authentication program and a program (boot code) enabling the CPU 51 to execute the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

The motherboard 40 is provided with a main CPU 41 (controller), a ROM (Read Only Memory) 42, a RAM (Random Access Memory) 43 and a communication interface 44.

The main CPU 41 has functions of a controller for controlling the whole slot machine 10. In particular, the main CPU 41 carries out a control for outputting a command signal enabling the sub CPU to scroll the symbols of the lower image display panel 16 when the spin button 23 is pushed after the credit is bet, a control for determining symbols to be stopped after the symbols are scrolled and a control for stopping the determined symbols in the display windows 151˜155.

In other words, the main CPU 41 has functions of an arrangement controller for selecting and determining arrangement symbols with regard to a symbol matrix from the plural types of symbols so as to rearrange them, as a new symbol matrix after scrolling the plural symbols to be displayed in the lower image display panel 16, and executing an arrangement control which will be stopped at the determined symbols from the scroll state.

In addition, the main CPU 41 has functions of the game controller 182 for executing a first process of setting at least one of the selection object symbols having a type corresponding to a selection signal inputted from the touch panel 69, as a scatter symbol, a second process of rearranging the symbols to award a payout determined by a combination of the symbols 180 rearranged on the payline L and a third process of awarding a payout determined on the basis of the scatter symbols 182 rearranged on and out of the payline L. Further, the main CPU 41 has a function of the game controller 100 for executing a fourth process of providing the arrangement area for arranging the plural symbols 180 and the selection area for displaying the selection object symbols 181 to different parts of the display unit 101.

The ROM 42 stores a program such as BIOS (Basis Input/Output System) executed by the main CPU 41, and data that is permanently used. When the BIOS is executed by the main CPU 41, each of peripheral devices is initialized and the game program and the game system program stored in the memory card 53 are read out through the gaming board 50.

The RAM 43 stores the data or program which is used when the CPU 41 carries out a process. For example, in the RAM 43, the selection object symbol memory 105, the scatter symbol memory 106, the symbol memory 108 and the display symbol memory 107 shown in FIG. 2 are provided in a data area form. The data area of the selection object symbol memory 105 stores the selection object symbols 181. The data area of the scatter symbol memory 106 stores the scatter symbol 182. The data area of the symbol memory 108 stores the symbols 180 in the data table form shown in FIG. 8. The data area of the display symbol memory 107 stores the symbols 180, the selection object symbols 181 and the scatter symbol 182.

The communication interface 44 is provided to communicate with a host computer and the like through a communication line, which are mounted in the game arcade. In addition, the motherboard 40 is connected to the main body PCB (Printed Circuit Board) 60 and the door PCB 80 through a USB (Universal Serial Bus). Further, the motherboard 40 is connected to a power unit 45. When power is supplied to the motherboard 40 from the power unit 45, the main CPU 41 of the motherboard 40 is operated and the power is supplied to the gaming board 50 through the PCI bus, so that the CPU 51 is also operated.

The main body PCB 60 and the door PCB 80 are connected to a device or apparatus for producing an input signal which will be inputted to the main CPU 41, and a device or apparatus which is controlled by the control signal outputted from the main CPU 41. The main CPU 41 executes the game program and the game system program stored in the RAM 43, based on the input signal inputted to the main CPU 41 to carry out an arithmetic process, thereby storing a result thereof in the RAM 43 or transmitting a control signal to each device or apparatus to control it.

The main body PCB 60 is connected with a lamp 30, the sub CPU, a hopper 66, a coin sensor 67, a graphic board 68, the speaker 29, the touch panel 69, the bill validator 22, the ticket printer 35, the card reader 36, a key switch 38S and the data displayer 37.

The lamp 30 is turned on/off on the basis of the control signal outputted from the main CPU 41. The sub CPU controls the scroll of symbols of the display windows 151˜155 and is connected to a VDP (Video Display Processor). The VDP reads out image data of the symbol stored in an image data ROM, produces a scroll image to be displayed in the display windows 151˜155 and outputs the scroll image in the lower image display panel 16.

The hopper 66 is mounted in the cabinet 11 and pays out predetermined number of coins to the coin tray 18 from the coin payout opening 19, based on the control signal outputted from the main CPU 41. The coin sensor 67 is mounted in the coin payout opening 19 and outputs an input signal to the main CPU 41 when it detects that the predetermined number of coins are paid out from the coin payout opening 19.

The graphic board 68 controls an image display in the upper image display panel 33 and the lower image display panel 16, based on the control signal outputted from the main CPU 41. In addition,:the graphic board 68 is provided with a VDP for producing image data on the basis of the control signal outputted from the main CPU 41, a video RAM for temporarily storing the image data produced by the VDP, and the like.

The bill validator 22 reads an image of the bill and accommodates the normal bill in the cabinet 11. In addition, in accommodating the normal bill, the bill validator 22 outputs an input signal to the main CPU 41, based on an amount of the bill. The main CPU 41 stores a credit-number, which corresponds to the amount of the bill transmitted by the input signal, in the RAM 43.

The ticket printer 35 prints a barcode having data encoded thereto, such as credit-number stored in the RAM 43, date and time, identification number of the slot machine 10 and the like, on a ticket, based on the control signal outputted from the main CPU 41, thereby outputting the ticket 39 having the barcode.

The card reader 36 reads the data from the smart card to transmit it to the main CPU 41, and writes the data into the smart card, based on the control signal outputted from the main CPU 41. The key switch 38S is mounted to the keypad 38, and outputs an input signal to the main CPU 41 when the player manipulates the keypad 38. The data displayer 37 displays the data which is read by the card reader 36 or the data which the player inputs through the keypad 38, based on the control signal outputted from the main CPU 41.

The door PCB 80 is connected with the control panel 20, a reverter 21S, a coin counter 21C and a cold cathode tube 81. The control panel 20 is provided with a spin switch 23S corresponding to the spin button 23, a change switch 24S corresponding to the change button 24, a cash out switch 25S corresponding to the cash out button 25, a 1-BET switch 26S corresponding to the 1-BET button 26 and a MAX-BET switch 27S corresponding to the MAX-BET button 27. Each of the switches 23S˜27S outputs an input signal to the main CPU 41 when each of the corresponding buttons 23˜27 is pushed by a player.

The coin counter 21C is mounted in the coin receiving slot 21 and validates whether a coin, which is inserted in the coin receiving slot 21 by the player, is normal or not. A coin except the normal coin is discharged from the coin payout opening 19. In addition, the coin counter 21C outputs an input signal to the main CPU 41 when it detects a normal coin.

The coin counter 21C is operated on the basis of the control signal outputted from the main CPU 41 and distributes a coin, which is recognized as a normal coin by the coin counter 21C, to a cash box (not shown) or hopper 66 mounted in the slot machine 10. In other words, when the hopper 66 is fully filled with the coins, the normal coin is distributed into the cash box by the reverter 21S. In the mean time, when the hopper 66 is not fully filled with the coins, the normal coin is distributed into the hopper 66. The cold cathode tube 81 functions as a backlight mounted to rear sides of the lower image display panel 16 and the upper image display panel 33 and is turned on, based on the control signal outputted from the main CPU 41.

(Processing Operation)

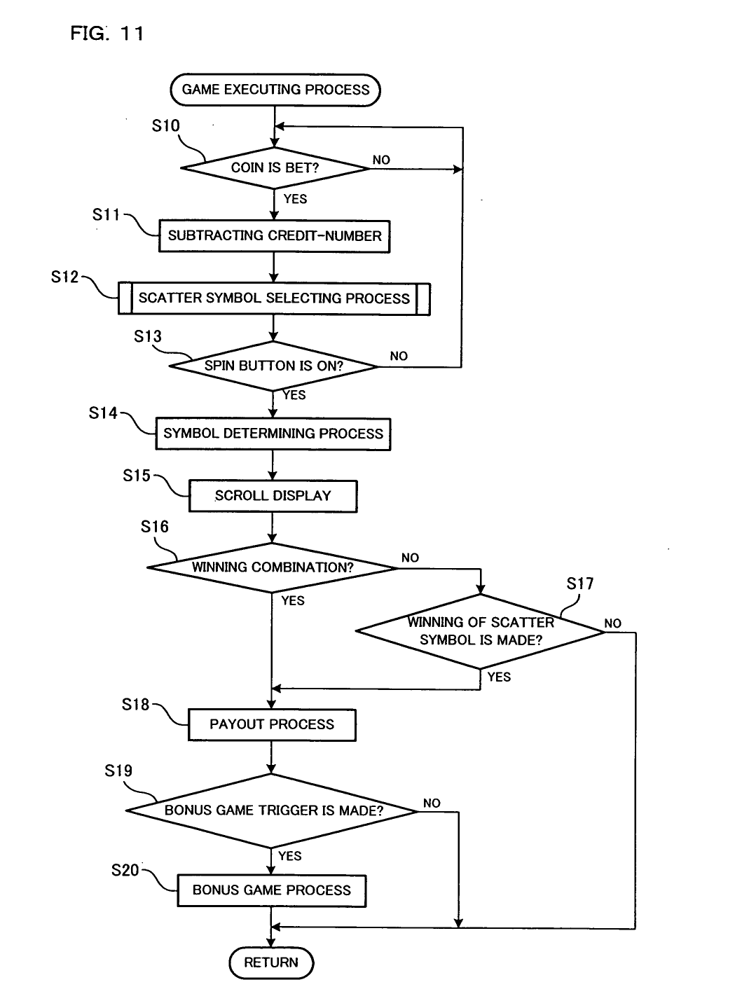

In the followings, it will be described a process which is carried out in the slot machine 10. When the main CPU 41 reads out and executes the game program, a game is started. As shown in FIG. 11, in the game executing process, it is determined whether a coin is bet (S10). In this process, it is determined whether it is received an input signal from the 1-BET switch 26S as the 1-BET button 26 is pushed and whether it is received an input signal from the MAX-BET switch 27S as the MAX-BET button 27 is pushed. When the coin is not bet (S10, NO), the step of S10 is re-executed and it is under standby state until a coin is bet.

In the mean time, when the coin is bet (S10, YES), the credit-number stored in the RAM 43 is subtracted, correspondingly to the number of coins bet (S11). Meanwhile, if the number of coins bet is larger than the credit-number stored in the RAM 43, it is not carried out the process of subtracting the credit-number and the step of S11 is re-executed. In addition, if the number of coins bet is above the upper limit (50 pieces in this embodiment) which can be bet per one game, it is not carried out the process of subtracting the credit-number and a step of S12 is carried out.

Next, a scatter symbol selecting process is carried out (S12). Specifically, it is carried out a scatter symbol selecting process routine. First, as shown in FIG. 3, “BELL,” “CHERRY” and “ORANGE,” which are the selection object symbols 181, are displayed in the selection windows 161, 162, 163, respectively. In addition, at the same time, the received thing (scatter symbol 182) of the scatter symbol display unit 171 disappears.

Thereby, the player can intuitively recognize that the player can select the scatter symbol 182 among the selection object symbols 181 by observing a state in which the received thing is not displayed in the scatter symbol display unit 171 and a state in which the selection object symbols 181 are displayed in the selection windows 161, 162, 163, with naked eyes. In addition, the player can enjoy that the player can freely select the scatter symbol 182 among the plural types of selection object symbols 181.

Next, as shown in FIG. 4, when the touch panel 69 is pushed by a player's hand 190, a selection signal outputted from the touch panel 69 is introduced (S101). After that, it is determined whether the player has pushed the selection object symbol 181, based on the selection signal (S102). When the selection object symbol 181 has been pushed (S102, YES), the selection object symbol 181 is stored as the scatter symbol 182. In other words, the selection object symbol is stored in the data area of the RAM 43 formed as the scatter symbol memory 106 of FIG. 2 (S103). Then, a step of S106 is carried out.

In the mean time, when the player does not push the selection object symbols (S102, NO), such as a case where the player is pushing the symbols 180 of the display windows 151˜155, it is continuously determined whether allowed selection time has lapsed (S104). When the allowed selection time has not lapsed (S104, NO), the process of S101 is executed, so that it is next introduced a selection signal from the touch panel 69. When the allowed selection time has lapsed (S104, YES), the scatter symbol 182 is automatically selected among the selection object symbols 181 and stored in the data area of the RAM 43 formed as the scatter symbol memory (S105).

After that, the selection object symbol 181 is moved to the scatter symbol display unit 171 and is displayed as a received thing of the scatter symbol display unit 171, so that it is notified that the selection object symbol 181 selected is set as the scatter symbol 182 (S106). After that, as shown in FIG. 5, the selection object symbols 181 are removed from the selection windows 161, 162, 163, so that it is notified that the selection of the scatter symbol 182 has been completed (S107). Then, the execution is returned to the game execution processing routine from this routine.

As shown in FIG. 11, when the execution is returned to the game execution processing routine, it is determined whether the spin button 23 is ON or not (S13). When the spin button 23 is not ON (S13, NO), the procedure is returned to the step of S10. Meanwhile, in case that the spin button 23 has not been ON (for example, the spin button 23 is not ON and an instruction to end the game is inputted), it is canceled the subtraction result in the step of S11.

In the mean time, when the spin button 23 is ON (S13, YES), a symbol determining process is executed (S14). In other words, a stop symbol determining program stored in the RAM 43 is executed, so that it is determined the symbols 180 which will be stopped in the fifteen respective stages of the display windows 151˜155. Thereby, it is determined a combination of symbols to be stopped on the payline L.

Next, as shown in FIG. 6, the symbols 180 of the display windows 151˜155 are scroll-displayed. In the mean time, the scroll process is such that the symbols 180 are scrolled in an arrow direction and then the symbols 180 determined in the step of S14 are stopped (rearranged) in the display windows 151˜155.

Next, as shown in FIG. 7, it is determined whether a combination of symbols 180 stopped on the payline L is a winning combination or not (S16). When it is not a winning combination (S16, NO), it is continued to determine whether it is made a winning resulting from a display (rearranged) of the scatter symbol 182 in the display windows 151˜155 (S17). When the scatter symbol 182 is not displayed, i.e., a winning is not made (S17, NO), this routine is ended.

In the mean time, when it is a winning combination (S16, YES) and/or it is made a winning resulting from a display of the scatter symbol 182 (S17, YES), a step of S18 is executed. In other words, it is summed up a payout-number of coins based on the winning combination and a payout-number of coins based on the display of the scatter symbol 182. Then, in case that the paid out coins are deposited, a predetermined credit-number is added to the credit-number stored in the RAM 43. In the mean time, in case that the coins are paid out, a control signal is transmitted to the hopper 66 to pay out a predetermined number of coins.

In the mean time, in the display state of FIG. 7, it is not made a winning combination. In addition, since “BELL” is set as the scatter symbol 182, five scatter symbols 182 (“BELL”) are displayed in the display windows 151˜155. As a result, the coins corresponding to the 5 scatter symbols 182 (“BELL”) are paid out (S18).

Next, it is determined whether it is made a bonus trigger as a winning combination. In other words, it is determined whether a combination of “APPLE” is arranged on the payline L (S19). When it is determined that the bonus trigger is made (S19, YES), it is executed a bonus game process (S20). In the mean time, when the bonus trigger is not made (S19, NO), it means a losing. As a result, this routine is ended.

### Embodiment 2

It will be described an embodiment 2 of the slot machine 19 and the playing method thereof, according to the invention. In the mean time, the same members as the embodiment 1 are referred to with the same reference numerals and descriptions thereof are thus omitted.

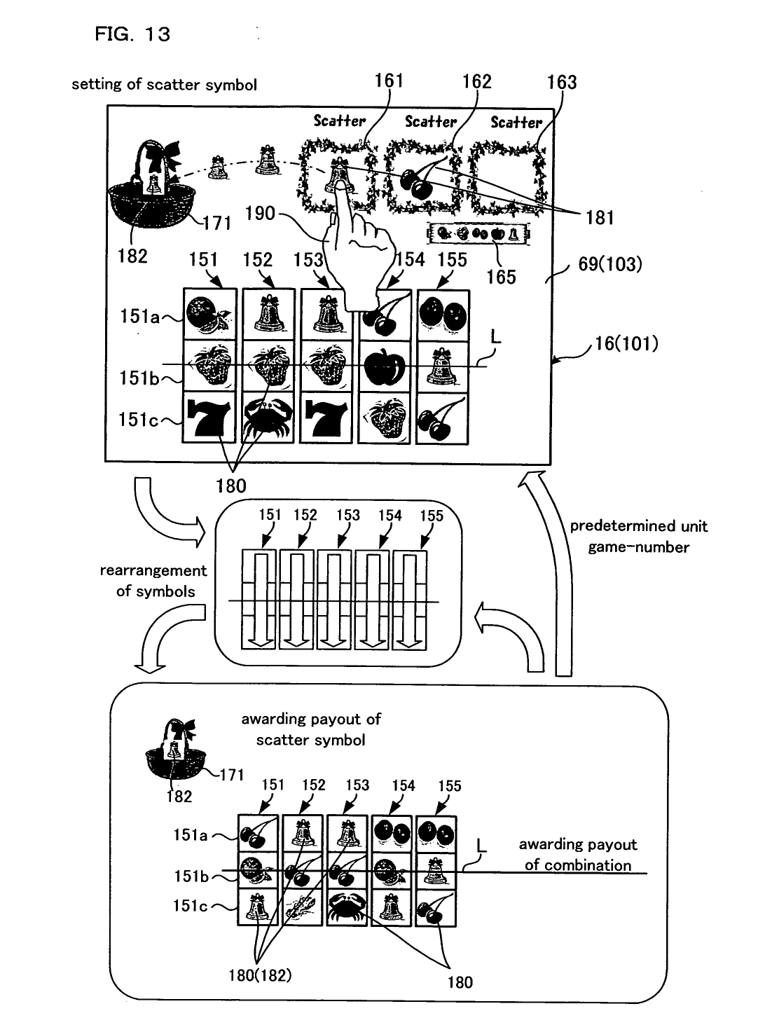

As shown in FIG. 13, the slot machine carries out a playing method comprising steps of: receiving selection of a scatter symbol 182 after a next game, in case that it becomes a predetermined unit game-number after selecting the scatter symbol 182; and changing a selection-number of the selection object symbols 181 in case of receiving the selection of the scatter symbol 182, in addition to the steps of the playing method in the embodiment 1. In the mean time, FIG. 13 shows a state that two scatter symbols 182 consisting of “BELL” and “CHERRY” are selected among the five selection object symbols 181. The other structures are same as the embodiment 1.

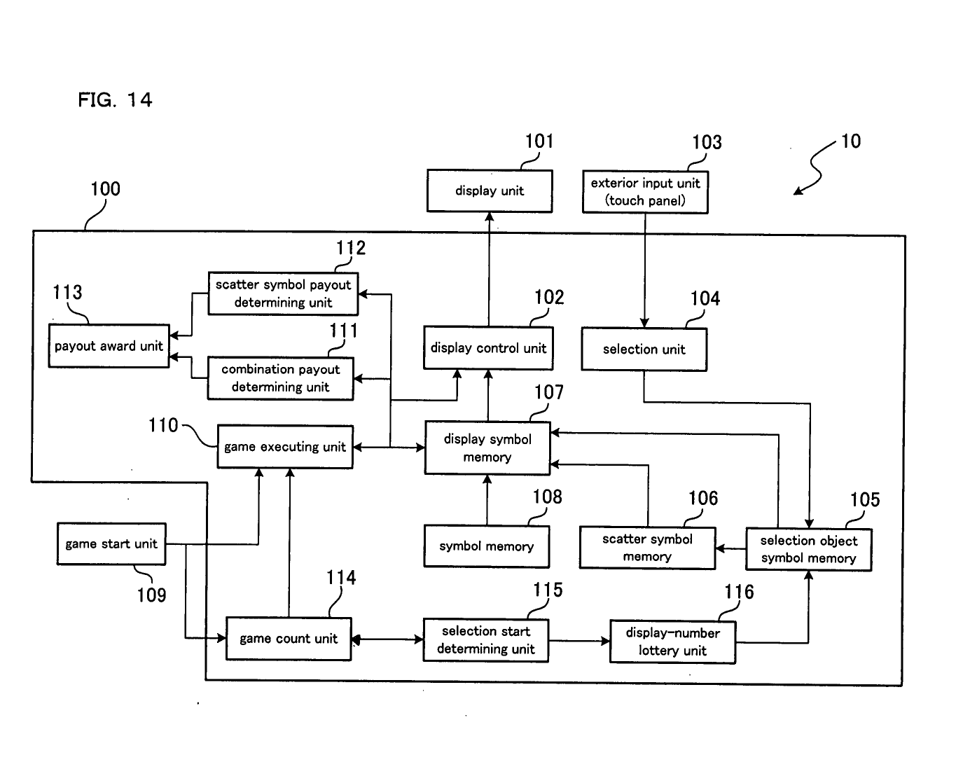

The slot machine 10 of the invention has a display unit (display) 101 and a game controller 100, as shown in FIG. 14. The display unit 101 has a payline L and is structured to arrange plural symbols including a scatter symbol.

The game controller 100 is structured to execute a fifth process of receiving selection of a scatter symbol after a next game in case that it becomes a predetermined unit game-number after selecting a scatter symbol, in addition to the first to fourth processes of the embodiment 1. Further, the slot machine 10 is structured to execute a sixth process of changing a selection-number of the selection object symbols in case of receiving the selection of the scatter symbol. In other words, the game controller 100 has plural types of selection object symbols and first, second, third, fourth, fifth and sixth processing units.

(Game Controller 100)

The game controller 100 is provided with a game count unit 114 to which a game start signal is inputted from a game start unit 109, a selection start determining unit 115 to which a count value signal is inputted from the game count unit 114 and a display-number lottery unit 116 to which a determining signal is inputted from the selection start determining unit 115.

Whenever a game start signal is inputted, the game count unit 114 counts up a unit game-number and outputs the number of unit games as a count value signal. When the unit game-number of the count value signal is a predetermined number, the selection start determining unit 115 outputs a selection start signal to the game count unit 114 and the display lottery unit 116. The game count unit 114 clears the unit game-number to “0”, based on the selection start signal inputted. In the mean time, the display lottery unit 116 determines a display-number of the selection object symbols with the input of the selection start signal as trigger, and determines the selection object symbols as the display-number. The display lottery unit 116 outputs the selection object symbols as the display-number to the display symbol memory 107 from the selection object symbol memory 105, thereby displaying the selection object symbols as the display-number in the display unit 101. The other structures are same as the embodiment 1.

In the structure as described above, an operation of the slot machine 100 is described.

Whenever a game start signal is inputted from the game start unit 109, the unit game-number is counted up in the game start unit 109. The unit game-number is outputted to the selection start determining unit 115, as a count value signal. When the unit game-number is a predetermined number, a selection start signal is outputted to the game start unit 109. Then, a display-number of the selection object symbols is determined and the selection object symbols as the display-number are determined in the display lottery unit 116. After that, the selection object symbols as the display-number are outputted to the display symbol memory 107 from the selection object symbol memory 105, so that the selection object symbols as the display-number are displayed in the, display unit 101. The other operations are same as the embodiment 1.

As a result, the game controller 100 carries out the fifth process of receiving selection of a scatter symbol after a next game, in case that it becomes a predetermined unit game-number after selecting a scatter symbol on the basis of the selection object symbols displayed in the display unit 101. In addition, the game controller 100 executes the sixth process of changing a selection-number of the selection object symbols in case of receiving the selection of the scatter symbol.

As can be clearly seen from the above operations, the slot machine 10 embodies a playing method of receiving selection of a scatter symbol after a next game, in case that it becomes a predetermined unit game-number after selecting a scatter symbol. In addition, the slot machine 10 embodies a playing method of changing a selection-number of the selection object symbols in case of receiving the selection of the scatter symbol.

(Display State)

It is specifically described an example of a display state during the operations of the slot machine 10 and the playing method thereof. A display state in the display unit 101 of FIG. 13 shows a state allowing a scatter symbol 182 to be selected among the two selection object symbols 181. In addition, a selection object window 165 is provided below the selection windows 161,162, 163. The selection object window 165 displays symbols which are candidates of the selection object symbols 181. Accordingly, a player can intuitively recognize that the selection object symbols 181 are selected among the candidate symbols displayed in the selection object window 165 and then displayed in the selection windows 161, 162, 163.

(Processing Operation)

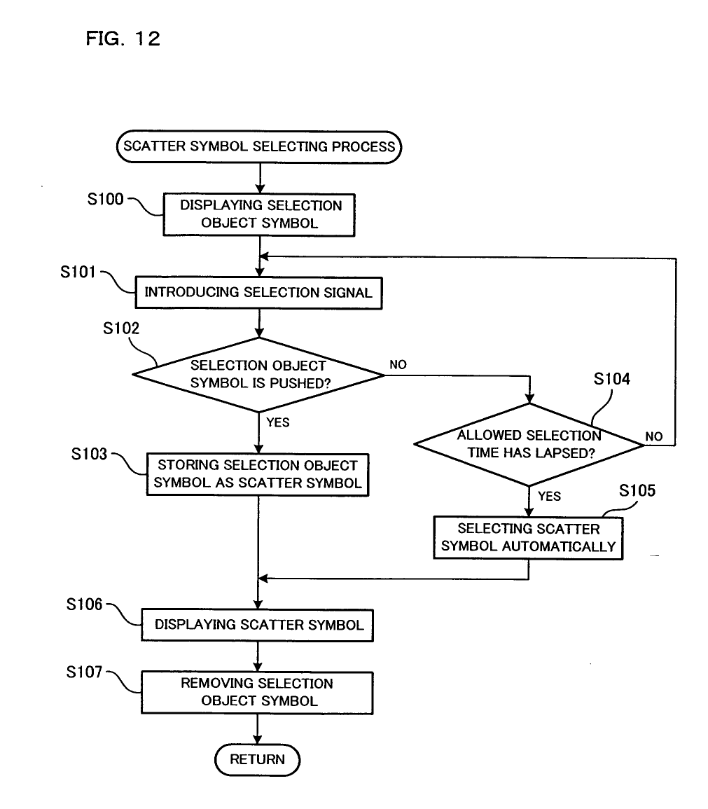

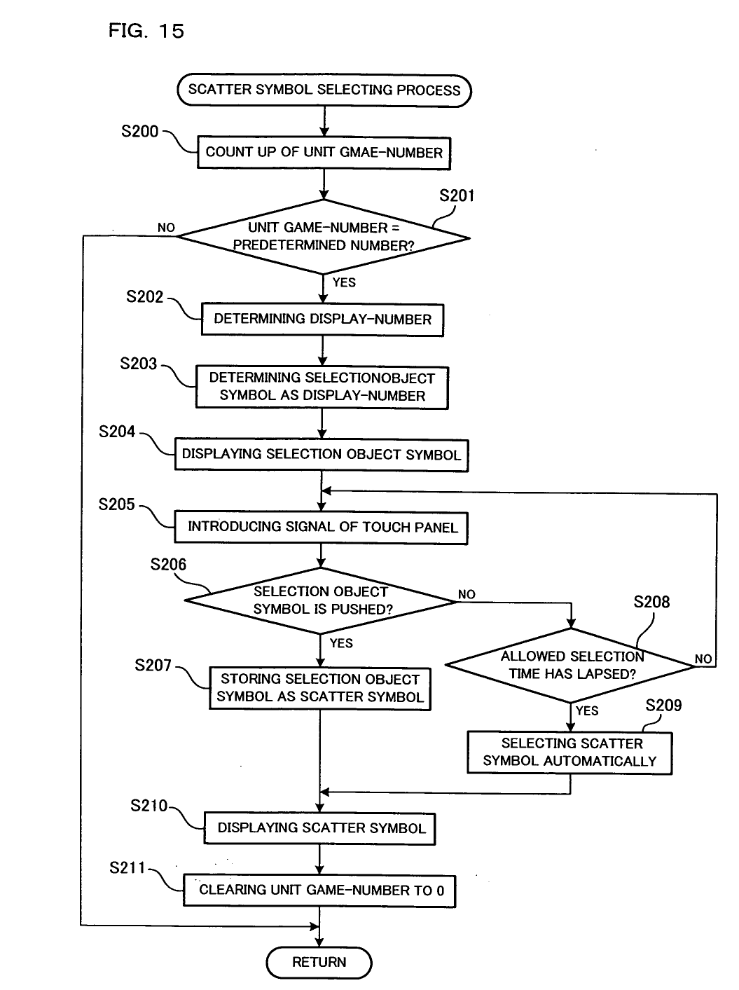

The slot machine 12 has the same mechanical and electrical structures as the embodiment 1, except that the process routine in FIG. 12 is replaced with a process routine in FIG. 15. In the followings, it will be specifically described a processing operation of the slot machine 10, based on a process routine in FIG. 15.

In the game executing process of FIG. 10, when a scatter symbol selecting process is executed (S12), a scatter symbol process routine of FIG. 15 is carried out. First, a unit game-number is counted up (S200). Then, it is determined whether the unit game-number is a predetermined value (S201). When the unit game-number is not a predetermined value (S201, NO), this routine is ended and the process is returned to the game executing process of FIG. 10. Accordingly, in this case, a unit game is repeated using a same type of scatter symbol 182.

In the mean time, when the unit game-number is a predetermined value (S201, YES), a display-number is determined and then the selection object symbols 181 as the display-number are determined by a lottery (S203). After that, the selection object symbols 181 determined are displayed in the selection windows 161, 162, 163 (S204). As a result, the player can recognize that the scatter symbol 182 can be selected after playing a predetermined number of games. In addition, the player can enjoy that it is possible to play a next game using a different type of a scatter symbol 182 from the scatter symbol 182 to date. Furthermore, when two selection object symbols 181 are determined, the two selection object symbols 181 are displayed in the selection windows 161,162 and the remaining selection window 163 is maintained to be empty. As a result, the player can select a scatter symbol 182 among the two selection object symbols 181. At this time, since the type or number of the selectable selection object symbols 181 is varied, it is easily preferred by a player who cares about a jinx.

Next, when the touch panel 69 is pushed by a player's hand 190, it is introduced a selection signal outputted from the touch panel 69 (S205). After that, it is determined whether the player has pushed the selection object symbol 181, based on the selection signal (S206). When the selection object symbol 181 has been pushed (S207, YES), the selection object symbol 181 is memorized as a scatter symbol 182 (S207) and a process of S210 is executed.

In the mean time, when the selection object symbol 181 is not pushed (S206, NO), it is continuously determined whether the allowed selection time has lapsed (S208). When the allowed selection time has not lapsed (S206, NO), the process of S205 is executed, so that it is introduced a next selection signal from the touch panel 69. When the allowed selection time has lapsed (S208, YES), a scatter symbol 182 is automatically selected and memorized among the selection object symbols 181 displayed (S209).

After that, the selection object symbol 181 selected is moved to the scatter symbol display unit 171 and is displayed as a received thing of the scatter symbol display unit 171, so that it is notified that the selection object symbol 181 selected has been set as the scatter symbol 182 (S210). After that, the selection object symbol 181 is removed from the selection windows 161,162, 163, so that it is notified that the selection of the scatter symbol 182 has been completed. The unit game-number is cleared to “0” (S211) and then the process is returned to the game executing process routine from this routine. The other operations are same as the embodiment 1.

### Embodiment 3

In the followings, it will be described an embodiment 3 of the slot machine 10 and the playing method thereof, according to the invention.

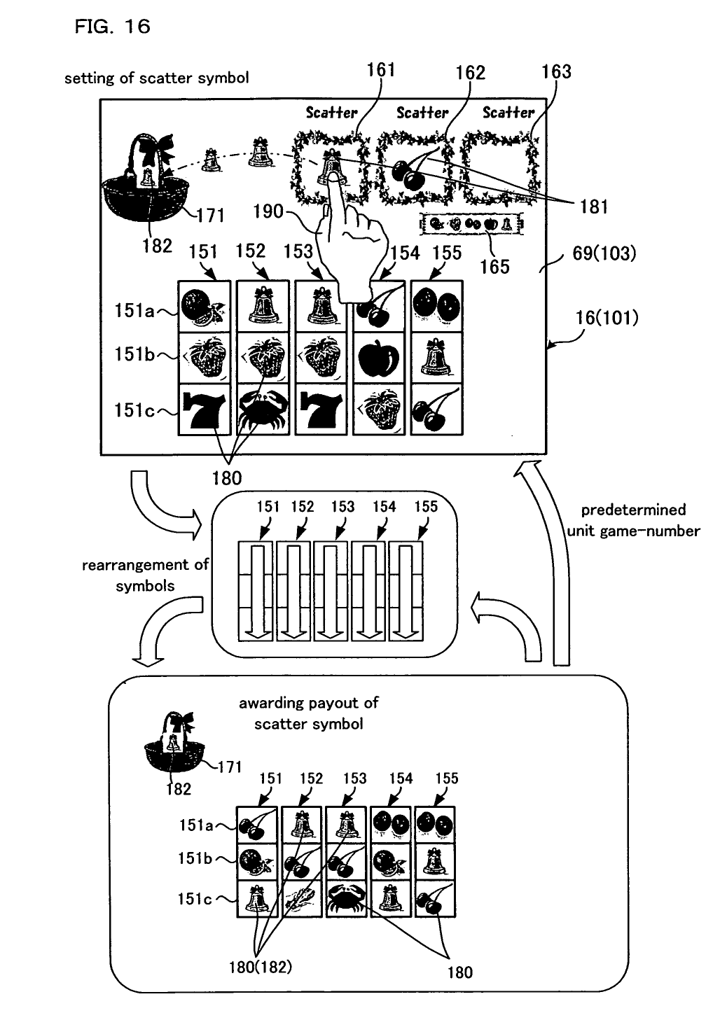

As shown in FIG. 16, the slot machine executes a playing method comprising steps of receiving a selection signal from an exterior, setting, among the plural types of selection object symbols 181, at least one of the selection object symbols 181 having a type corresponding to the selection signal, as a scatter symbol 182, rearranging the plural symbols 180 including the scatter symbol 182 in the display unit 101 and awarding a payout determined on the basis of the scatter symbol 182 rearranged.

Further, the slot machine 10 executes a playing method comprising a step of providing the display windows 151˜155, which are the arrangement area for arranging the plural symbols 180, and the selection windows 161,162, 163, which are the selection area for selecting the selection object symbols 181, to different parts of the display unit 101.

Further, the slot machine 10 carries out a method comprising steps of receiving selection of a scatter symbol 182 after a next game in case that it is made a predetermined unit game-number after selecting the scatter symbol 182, and changing a selection-number of the selection object symbols 181 in case of receiving the selection of the scatter symbol 182. Since the other operations and structures are same as the embodiment 1 or 2, except that there is no operation or block (scatter symbol payout determining unit 11 in FIG. 2) related to the payline L, the descriptions thereof are omitted.

In addition, although the above descriptions have been provided with regard to the characteristic parts so as to understand the invention more easily, the invention is not limited to the embodiments as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A slot machine comprising:
a display having a payline and arranging plural symbols including a scatter symbol, and
a game controller having plural types of selection object symbols, setting at least one of the selection object symbols having a type corresponding to a selection signal inputted from an exterior, as the scatter symbol and rearranging the symbols to award a payout determined by a combination of the symbols rearranged on the payline and to award a payout determined on the basis of the scatter symbols rearranged on and out of the payline.

2. A slot machine comprising:
a display arranging a scatter symbol, and
a game controller has plural types of selection object symbols, setting at least one of the selection object symbols having a type corresponding to a selection signal inputted from an exterior, as the scatter symbol, rearranging the scatter symbol and awarding a payout determined on the basis of the scatter symbol rearranged.

3. The slot machine according to claim 1, wherein the game controller provides an arrangement area for arranging the plural symbols and a selection area for displaying the selection object symbols to different parts of the display.

4. The slot machine according to claim 1, wherein the game controller receives selection of the scatter symbol after a next game, when it is made a predetermined unit game-number after selecting the scatter symbol.

5. The slot machine according to claim 1, wherein the game controller changes a selection-number of the selection object symbols, when it receives the selection of the scatter symbols.

6. A slot machine comprising:
a display having a payline and arranging plural symbols including a scatter symbol, and
a game controller providing an arrangement area for arranging the plural symbols and a selection area for displaying selection object symbols to different parts of the display, having plural types of selection object symbols to be displayed in the selection area, setting at least one of the selection object symbols having a type corresponding to a selection signal inputted from an exterior, as the scatter symbol, rearranging the symbols to award a payout determined by a combination of the symbols rearranged on the payline and to award a payout determined on the basis of the scatter symbols rearranged on and out of the payline, and receiving selection of the scatter symbol after a next game when it is made a predetermined unit game-number after selecting the scatter symbol.

7. A slot machine comprising:
a display having a payline and arranging plural symbols including a scatter symbol, and
a game controller providing an arrangement area for arranging the plural symbols and a selection area for displaying selection object symbols to different parts of the display, changing a selection-number of the selection object symbols to be displayed in the selection area, setting, among the selection object symbols, at least one of the selection object symbols having a type corresponding to a selection signal inputted from an exterior, as the scatter symbol, and rearranging the symbols to award a payout determined by a combination of the symbols rearranged on the payline and to award a payout determined on the basis of the scatter symbols rearranged on and out of the payline.

8. A slot machine comprising:
a display having a payline and arranging plural symbols including a scatter symbol, and
a game controller providing an arrangement area for arranging the plural symbols and a selection area for displaying selection object symbols to different parts of the display, changing a selection-number of the selection object symbols to be displayed in the selection area, setting, among the selection object symbols, at least one of the selection object symbols having a type corresponding to a selection signal inputted from an exterior, as the scatter symbol, rearranging the symbols to award a payout determined by a combination of the symbols rearranged on the payline and to award a payout determined on the basis of the scatter symbols rearranged on and out of the payline, and receiving selection of the scatter symbol after a next game when it is made a predetermined unit game-number after selecting the scatter symbol.

9. A playing method of a slot machine having structures below, comprising:
receiving a selection signal from an exterior;
setting, among plural types of selection object symbols, at least one of the selection object symbols having a type corresponding to the selection signal, as a scatter symbol;
rearranging plural symbols including the scatter symbol in a display, and
awarding a payout determined by a combination of the symbols rearranged on a payline and a payout determined on the basis of the scatter symbols rearranged on and out of the payline.

10. A playing method of a slot machine having structures below, comprising:
receiving a selection signal from an exterior;
setting, among plural types of selection object symbols, at least one of the selection object symbols having a type corresponding to the selection signal, as a scatter symbol;
rearranging the scatter symbol in a display, and
awarding a payout determined on the basis of the scatter symbol rearranged.

11. The playing method according to claim 9, wherein an arrangement area for arranging the plural symbols and a selection area for displaying the selection object symbols are provided to different parts of the display.

12. The playing method according to claim 9, receiving selection of the scatter symbol after a next game, when it is made a predetermined unit game-number after selecting the scatter symbol.

13. The playing method according to claim 9, changing a selection-number of the selection object symbols, when receiving the selection of the scatter symbol.

14. A playing method of a slot machine having structures below, comprising:
providing an arrangement area for arranging the plural symbols and a selection area for displaying selection object symbols to different parts of a display;
receiving a selection signal from an exterior;
setting, among the plural types of the selection object symbols, at least one of the selection object symbols having a type corresponding to the selection signal, as a scatter symbol;
rearranging the plural symbols including the scatter symbol in the display;
awarding a payout determined by a combination of the symbols rearranged on a payline and a payout determined on the basis of the scatter symbols rearranged on and out of the payline, and
receiving selection of the scatter symbol after a next game, when it is made a predetermined unit game-number after selecting the scatter symbol.

15. A playing method of a slot machine having structures below, comprising:
providing an arrangement area for arranging the plural symbols and a selection area for displaying selection object symbols to different parts of a display;
receiving a selection signal from an exterior;
changing a selection-number of the selection object symbols to be displayed in the selection area;
setting, among the selection object symbols, at least one of the selection object symbols having a type corresponding to the selection signal, as a scatter symbol;
rearranging the plural symbols including the scatter symbol in the display;
awarding a payout determined by a combination of the symbols rearranged on a payline and a payout determined on the basis of the scatter symbols rearranged on and out of the payline.

16. A playing method of a slot machine having structures below, comprising:
providing an arrangement area for arranging the plural symbols and a selection area for displaying selection object symbols to different parts of a display;
receiving a selection signal from an exterior;
changing a selection-number of the selection object symbols to be displayed in the selection area;
setting, among the selection object symbols, at least one of the selection object having a type corresponding to the selection signal, as a scatter symbol;
rearranging the plural symbols including the scatter symbol in the display;
awarding a payout determined by a combination of the symbols rearranged on a payline and a payout determined on the basis of the scatter symbols rearranged on and out of the payline, and
receiving selection of the scatter symbol after a next game, when it is made a predetermined unit game-number after selecting the scatter symbol.
